(19) United States
(12) Patent Application Publication
(10) Pub. No.: US 2008/0002695 A1
(43) Pub. Date: Jan. 3, 2008

(54) PRESERVATION OF SESSION INFORMATION ON A COMMUNICATIONS NETWORK

(75) Inventors: Andrew J. Klotnia, Hoffman Estates, IL (US); Amarnath Chitti, Schaumburg, IL (US); Neeraj Jain, Hyderabad (IN); Von A. Mock, Boynton Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/427,334

(22) Filed: Jun. 28, 2006

(51) Int. Cl. H04L 12/56

(52) U.S. Cl. 370/392; 370/401

(57) ABSTRACT

A method (400) for preserving a user's network experience. The method can include, for at least one network resource (135) accessed during a user session, selectively storing session information (140) associated with the network resource. The session information can include, for example, content provided by the network resource, an attribute associated with the network resource, and/or associated transport layer session information. The session information can be stored on a network server (120) or on a communication device (115). The session information can be associated with the user session and a session identifier (155) can be associated with the session information. A request can be received from a user to access the session information and, responsive to verifying that the user is authorized to access the session information, the session information can be provided to the user.

### BACKGROUND OF THE INVENTION

1. Field of the Invention

The present invention generally relates to network communications and, more particularly, to user sessions.

2. Background of the Invention

Use of the Internet as a tool to gather information has become ubiquitous throughout the industrialized world. For many people, the Internet is their primary information source when researching any of a myriad of topics. For example, consumers often use the Internet to research products and services they are interested in purchasing, students use the Internet when writing research papers and hobbyist use the Internet to keep in touch with the latest developments in their hobbies.

Internet users oftentimes find a webpage that contains information that is very valuable to them, but forget to save the uniform resource locator (URL) of the webpage. Internet browsers typically track the history of one's browsing experience, but usually only do so for a predetermined amount of time. Thus, if a person attempts to find a particular webpage visited weeks earlier, the URL for that page may no longer be contained in his browser's history folder. Even if the URL were still contained in the history folder, it may be difficult to find among all the other URLs that may contained in the folder. Another obstacle sometimes encountered by Internet users occurs when a website previously visited becomes unavailable. Thus, even if the user has saved the URL, the website contents may have become inaccessible.

### SUMMARY OF THE INVENTION

The present invention relates to a method for preserving a user's network experience. The method can include, for at least one network resource accessed during a user session, selectively storing session information associated with the network resource. The session information can include, for example, content provided by the network resource, an attribute associated with the network resource, and/or transport layer session information. The session information can be stored on a network server or on a communication device. The session information can be associated with the user session. In addition, a session identifier can be associated with the session information. A request can be received from a user to access the session information and, responsive to verifying that the user is authorized to access the session information, the session information can be provided to the user.

The user session can be established using a tunneling protocol between a communication device and the network server. A dedicated traffic channel also can be established between the communication device and the network server. In one arrangement, the method can include establishing the user session between a first communication device and the network server, and the session information can be communicated to a second communication device. Further, the request can be received from a first user who established the user session, or a second user who did not establish the user session.

The method also can include receiving a user profile from an administrator and, based on the user profile, filtering the session information to block access by a profiled user to session information that the profiled user is not authorized to access. In addition, an attempt by the profiled user to access session information that the profiled user is not authorized to access can be identified, and an alert can be sent to the administrator in response to the attempt.

The present invention also relates to a network server. The network server can include a processor that, for at least one network resource accessed during a user session, selectively stores session information associated with the network resource. The processor also can associate the session information with the user session. In addition, the processor can receive a request from a user to access the session information and, responsive to verifying that the user is authorized to access the session information, provide the session information to the user. The processor also can establish the user session with a first communication device and the processor can communicate the session information to a second communication device. The user session established with the first communication device can be established in accordance with a tunneling protocol. The network server also can include a datastore for storing the session information. In another arrangement, the processor can communicate the session information to a communication device for storage.

The present invention also relates to an electronic apparatus. The electronic apparatus can include a user interface that presents to a user an option for selectively storing session information associated with a network resource. The user interface can include at least one indicator that indicates whether the session information is currently being stored for a current user session. In addition, the indicator can indicate whether session information associated with a previous user session is available to be accessed. Further, the indicator can be selected to access the stored session information for the current user session or the previous user session.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 is a signal flow diagram that is useful for understanding the present invention;

FIG. 3 depicts a block diagram of an example of a network server that is useful for understanding the present invention;

FIG. 4 is a flowchart presenting a method for preserving session information that is useful for understanding the present invention; and

FIG. 5 is a flowchart presenting a method for accessing stored session information that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for preserving a user's network experience on a communications network. Session information, such as content of network resources searched during a browsing session, associated attributes, and associated transport layer session information, can be stored to a desired location and a session identifier can be associated with the session information. Accordingly, the user can select or enter the session identifier at any time to access the stored session information. Thus, even if network resources that were searched during the original user session become unavailable, the user still can retrieve content of the network resources and associated attributes from the storage location. Moreover, the session information can be retrieved not only by the device on which the information was originally accessed by the user, but also by any other suitable devices communicatively linked to the storage location. Further, the user can share the session identifier with other users to enable the other users to also access the stored session information.

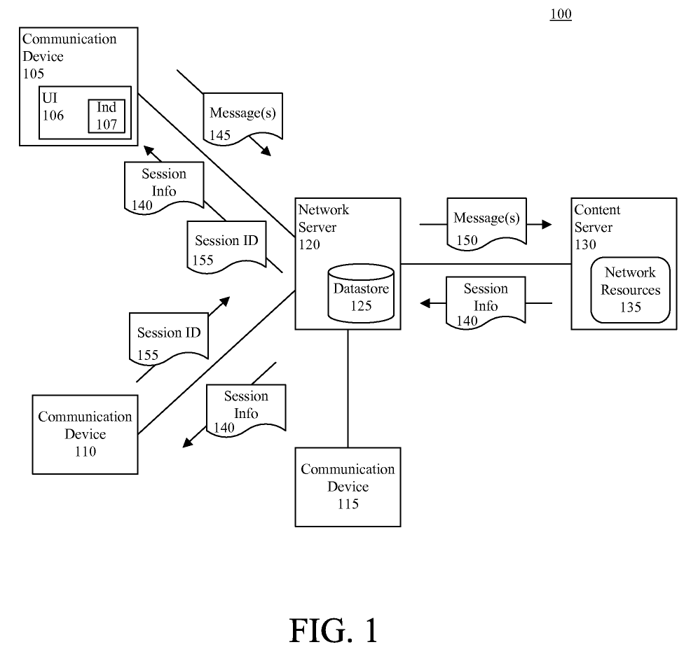

FIG. 1 depicts a communications system 100 that is useful for understanding the present invention. The communications system 100 can include a communication device 105 communicatively linked to a network server 120 via a communications network. Optionally, one or more additional communication devices, such as a communication device 110 and a communication device 115, also may be communicatively linked to the network server 120 via the communications network.

The communications network can include, for example, the Internet, the World Wide Web, a wide area network (WAN), a local area network (LAN), a cellular communications network, a dispatch communications network, a public switched telephone network (PSTN), and/or any other networks or systems over which communication signals can be propagated. In that regard, the communications network can include wired and/or wireless communication links.

The communication devices 105, 110, 115 can be computers, network appliances, mobile stations, such as mobile computers, mobile telephones or personal digital assistants (PDAs), or any other electronic apparatuses suitable for communicating with the network server 120. The network server 120 can be a computing device that comprises a datastore 125 and which is suitably configured for communicating with the communication devices 105, 110, 115. For example, the network server 120 can be a conventional server, a personal computer, a mobile station or a network appliance, although the invention is not limited in this regard. The datastore 125 can include a magnetic storage medium, an electronic storage medium, an optical storage medium, a magneto-optical storage medium, or any other storage medium suitable for storing data.

The communications system 100 also can include a content server 130. The content server 130 can be, for example, a web server that provides one or more network resources 135 which are accessible by the communication devices 105, 110, 115 and/or the network server 120. Examples of such network resources 135 can include websites, web pages, web portals, text, documents and code. Nonetheless, the invention is not so limited and the network resources 135 can include any other resources a user may access via the communications network.

In one arrangement, the communication devices 105, 110, 115 can communicate with the network server 120 using one or more tunneling protocols that enable Internet Protocol (IP) sessions to be seamlessly transferred across multiple network nodes (e.g. gateways). Examples of tunneling protocols that may be used include the secure socket layer (SSL) and the Real Time Streaming Protocol (RTSP), both of which operate over TCP/IP. Tunneling protocols which operate over the UDP/IP also may be used. Still, a variety of other tunneling protocols can be used and the invention is not limited in this regard. In addition, when one or more of the communication devices 105, 110, 115 communicate with the network server 120 over a wireless communication link, such as wideband code division multiple access (WCDMA), a dedicated traffic channel can be established between such communication devices 105, 110, 115 and the network server 120 on the wireless communication link.

In operation, the communication device 105 can establish a user session with the network server 120. The network server 120 can provide a user of the communication device 105 an option to store the user's session information 140. The session information 140 can include, for example, content provided by network resources 135 accessed by the user during the user session, attributes associated with the network resources 135, and/or associated transport layer session information. The attributes can include URLs to content servers or other network resources 135 accessed by the user, cookies, and/or other information.

To indicate to the user that storage of the session information 140 is an available option, the network server 120 can communicate a menu to be presented by a user interface 106 of the communication device 105. The menu can include a user selectable item that, when selected, indicates to the network server 120 to begin storing the session information 140. The user selectable item can be text, an icon, or any other suitable menu item. Alternatively, the network server 120 can be configured to recognize one or more signals received from the communication device 105 that indicate the session information 140 is to be stored. Such signals can be generated in response to one or more user inputs entered on the communication device 105.

Responsive to receiving a request indicating that user session information is to be stored, the network server 120 can begin storing the session information 140 as such information 140 is received from the content server 130, and/or any other content servers that may be accessed during the user session. For example, user messages 145 requesting the network resources 135 can be propagated from the communication device 105 to the network server 120. An example of one such message 145 can be a request that identifies a URL associated with the network resources 135. In response, the network server 120 can propagate a corresponding message 150 to the content server 130 requesting the network resources 135. The content server 130 can reply to the message 150 by providing the session information 140 associated with the network resources 135 to the network server 120.

One or more indicators 107 on the communication device 105 can indicate when the session information 140 is being stored for the current user session. The indicators 107 can be, for example, icons, text, or any other suitable indicators presented on a display of the communication device 105, light emitting diodes that illuminate, tones generated by an output audio transducer, or a haptic responses. In one arrangement, at least one of the indicators 107 can be the user selectable item presented in the menu on the user interface 106. In an arrangement in which the communication device 105 is a computer, at least one of the indicators 107 can be presented as an icon in a system tray. Still, other indication means can be used and the invention is not limited in this regard.

Upon receiving the session information 140, the network server 120 can communicate such information to the communication device 105. In addition, the network server can store the session information 140 on the datastore 125. In another arrangement, the network server can forward the session information 140 to the communication device 110 or the communication device 115 for storage.

The session information 140 that is stored can be user selectable. For instance, the user can be prompted to select portions of the session information 140 that are to be stored and/or portions of the session information 140 that are not to be stored. In one arrangement, a menu can be provided on the user interface 106 of the communication device 105 which enables the user to toggle the storing process on and off. In addition, content filtering can be implemented to automatically block certain types of session information from being stored, for instance pop-ups and advertisements. With suitable content filtering in place, a user may be provided an option to store all unblocked session information in the background while the user continues to browse the network.

Additional messages 145 can be communicated to the network server 120 from the communication device 105. The additional messages 145 can contain requests to be directed to the content server 130, or another content server, and the process can continue until the user session is ended. Accordingly, the stored session information 140 can include content and attributes from one or more of the network resources 135 provided by one or more content servers 130 accessed by the user during the user session. Advantageously, because the session information 140 can be stored in this manner, such information can be retrieved by an authorized user at a later time, regardless of whether the session information 140 is still available from the content server 130.

Regardless of which session information 140 is stored or where it is stored, the network server 120 can associate the session information 140 with the user session. For example, the network server 120 can automatically associate a session identifier 155 with the session information 140. The session identifier 155 can be used by the user to access the stored session information 140 at a later time.

In one arrangement, the session identifier 155 can be automatically generated by the network server 120. The network server 120 then can communicate the session identifier 155 to the communication device 105 and/or otherwise store the session identifier 155 in a manner that makes the session identifier 155 accessible to the user. For instance, the session identifier 155 can be associated with a user profile stored on the network server 120 or elsewhere in the communications system 100.

In another arrangement, the user can be prompted to enter the session identifier 155. For instance, the user can select a name that identifies the type of content perused during the user session. An attribute, such as a user identifier, can be associated with the session identifier 155 to distinguish that session identifier 155 from session identifiers of other users which may have the same name.

One or more of the indicators 107 can be associated with the session identifier 155 and presented on the communication device 105. In addition, indicators 107 associated with session identifiers of previous user sessions that have been stored also can be presented. The indicators 107 can indicate whether such user sessions are available to be accessed. As noted, the indicators 107 can be presented in a menu of selectable items. An indicator 107 associated with a particular user session can be selected to access the stored session information for that user session.

In addition to being used by the user to access the session information 140, the session identifier 155 also can be used by other authorized users to access the session information 140. For example, the user of the communication device 105 may provide the session identifier 155 to a user of another communication device, such as the communication device 110. If the session identifier 155 includes, or is associated with, a user identifier, the user identifier would be needed as well. The session identifier 155 can be provided to the other user(s) via the communications network, for example in a text message or e-mail, or communicated in any other suitable manner. For instance, the user of the communication device 105 can verbally communicate the session identifier 155 to a second user using the communication device 110. In such an arrangement, the session identifier 155 can be entered by the second user to gain access the stored session information 140. In one arrangement, a user selectable indicator associated with the session identifier 155 can be presented by the communication device 110, and a user can select the indicator to access the stored session information 140.

If the session information 140 is stored on the network server 120, the session identifier 155 can be communicated from the communication device 105 or the communication device 110 to the network server 120 in order to access the session information 140. If the session information 140 is stored on the communication device 115, the session identifier 155 can be communicated to the communication device 115.

In another arrangement, on the user interface 106, a menu of selectable items, which includes the session identifier 155, can be presented to a user seeking access to the session information 140. For example, the menu can be provided from the network server 120 to the communication device 105 and/or the communication device 110 that has established a user session. The user can select the session identifier 155 from the menu to access the session information 140. Of course, suitable security protocols can be implemented to prevent access to the session information 140 by unauthorized users. For example, security codes, public keys, private keys, biometric identifiers and/or any other security information may be required to verify whether the user is authorized to access the session information. If the user is authorized, access to the session information can be granted. If, however, user authorization is not verified, the user can be denied access to the session information.

In yet another arrangement, an administrator of an account with which the communication device is associated 105 can be provided secured access to the session information 140 received by selected users. For example, in a personal and family security environment, parents or guardians can be provided access to web browsing sessions of their children. Such access can be provided via the user interface 106, or in any other suitable manner.

In addition, selectable session information filtering can be provided to allow administrators to establish user profiles and limit the session information 140 that may be accessed on the communication device 105. For example, based on a user profile received for the user, the network server 120 can filter the session information 140 to block access by the user to session information that the user not authorized to access. Further, the network server 120 can be configured to identify an attempt by the user to access session information that the user is not authorized to access, and send an alert to the administrator in response to the attempt. The alert can be conveyed in an e-mail, a pop-up message, a telephone call, or in any other suitable manner.

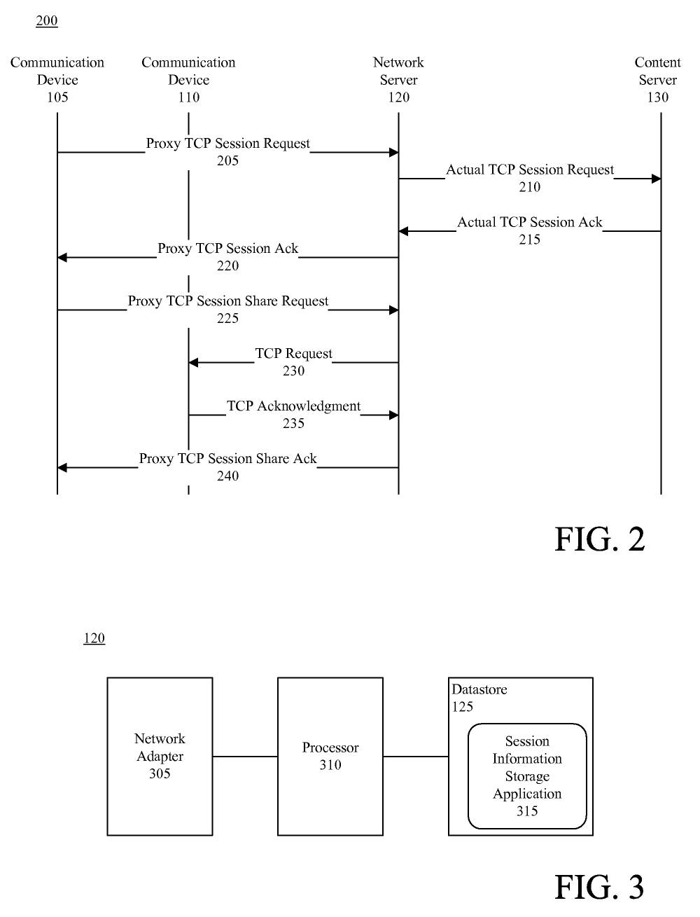

FIG. 2 is a signal flow diagram 200 that is useful for understanding the present invention. The flow diagram 200 is presented in the context of establishing transmission control protocol (TCP) sessions, but other protocols, such as user datagram protocol (UDP), can be used and the invention is not limited in this regard. Beginning at step 205, the communication device 105 can communicate a TCP session request to the network server 120. At step 210, the network server 120 can communicate an actual TCP session request to the content server 130. In response, at step 215 the content server 130 can communicate an actual TCP session acknowledgement to the server 120, thereby establishing a TCP session between the network server 120 and the content server 130. Proceeding to step 220, the network server 120 can communicate a proxy TCP session acknowledgment to the communication device 105, thereby establishing a proxy TCP session between the communication device 105 and the server 120.

In the present example, the term “proxy TCP session” means a TCP session in which requests for network resources are forwarded from the communication device 105 to the network server 120, and the network server 120 is tasked with establishing its own TCP session with the content server 130 to acquire content associated with the requested network resources. After the network content is acquired, the network server 120 can forward the network content to the communication device 105 using the proxy TCP session. Advantageously, if the proxy TCP session between the communication device 105 and the network server 120 is interrupted, the TCP session between the network server 120 and the content server 130 can be maintained. As noted, the TCP session between the communication device 105 and the network server 120 can be implemented using a suitable tunneling protocol to establish, for example, a TCP tunnel.

Steps 225-240 can be implemented if a user of the communication device 105 desires to share session information with the communication device 110, or an authorized user of the communalization device 110 is monitoring the network browsing activities of the communication device 110. At step 225 the communication device 105 can communicate a proxy TCP session share request to the network server 120. At step 230, the network server 120 can communicate a TCP request to the communication device 110. In response, at step 235 the communication device 110 can communicate a TCP acknowledgement to the network server 120 to establish a TCP session between the communication device 110 and the network server 120. This TCP session also can be implemented using a suitable tunneling protocol. Proceeding to step 240, a proxy TCP session share acknowledgment can be communicated from the network server 120 to the communication device 105 to indicate that sharing of session information with the communication device 110 has been established.

FIG. 3 depicts a block diagram of an example of the network server 120 that is useful for understanding the present invention. The network server 120 can include at least one network adapter 305 that is used by the network server 120 to communicate with communication devices and the content server(s). The network adapter 305 can be configured for wired communications and/or wireless communications. Such network adapters are known to the skilled artisan.

The network server 120 can include a processor 310. The processor 310 can comprise, for example, a central processing unit (CPU), a digital signal processor (DSP), an application specific integrated circuit (ASIC), a programmable logic device (PLD), a plurality of discrete components that cooperate to process data, and/or any other suitable processing device. A session information storage application 315, which may be stored on the datastore 125 or at another suitable location, can be executed by the processor 310 to implement the various methods and processes described herein.

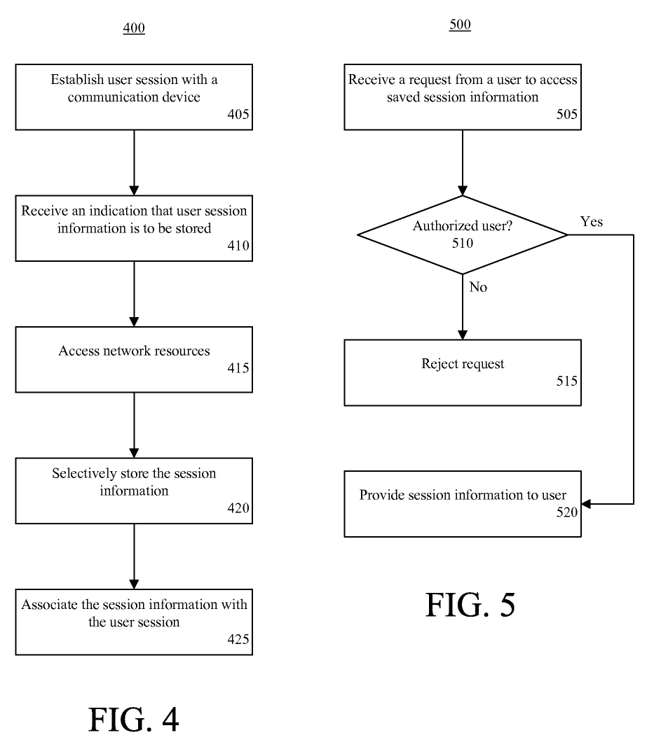

FIG. 4 is a flowchart presenting a method 400 for preserving session information that is useful for understanding the present invention. Beginning at step 405, a user session with a communication device can be established. At step 410, an indication can be received that user session information is to be stored. At step 415, network resources 135 can be accessed during the user session in response to user requests. Proceeding to step 420, session information for the user session can be selectively stored. For example, content of network resources 135 searched, associated attributes, and associated transport layer session information can be stored, while content of pop-up windows and advertisements can be ignored. The session information can be stored on a network server or another communication device. Continuing to step 425, the session information can be associated with the user session, for example using a session identifier.

FIG. 5 is a flowchart presenting a method 500 for accessing stored session information that is useful for understanding the present invention. Beginning at step 505, a request to access saved session information can be received from a user. The request can include, for example, a session identifier that is associated with the session information. Referring to decision box 510, if the user is not an authorized user, the request can be rejected at step 515. If, however, the user is an authorized user, at step 520 the session information can be provided to the user.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The term “network content,” as used herein, means any data which may be communicated over a communications network. For example, network content can include, but is not limited to, multimedia content (e.g. audio and/or video content), documents, software, code, hyperlinks, etc. The terms “computer program,”“software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for preserving a user's network experience, comprising:
for at least one network resource accessed during a user session, selectively storing session information associated with the network resource;
associating the session information with the user session;
receiving a request from a user to access the session information; and
responsive to verifying that the user is authorized to access the session information, providing the session information to the user.

2. The method of claim 1, wherein storing the session information comprises storing at least one type of information selected from the group consisting of content provided by the network resource, an attribute associated with the network resource, and transport layer session information.

3. The method of claim 1, further comprising establishing the user session between a first communication device and a network server, wherein providing the session information to the user comprises communicating the session information to a second communication device.

4. The method of claim 1, wherein receiving the request from the user comprises receiving the request from a first user who established the user session.

5. The method of claim 1, wherein receiving the request from the user comprises receiving the request from a second user who did not establish the user session.

6. The method of claim 1, wherein storing the session information comprises storing the session information on a network server.

7. The method of claim 1, wherein storing the session information comprises storing the session information on a communication device.

8. The method of claim 1, further comprising associating a session identifier with the session information.

9. The method of claim 1, further comprising establishing the user session using a tunneling protocol between a communication device and a network server.

10. The method of claim 1, further comprising establishing a dedicated traffic channel between a communication device and a network server.

11. The method of claim 1, further comprising:
receiving a user profile from an administrator; and
based on the user profile, filtering the session information to block access by a profiled user to session information that the profiled user is not authorized to access.

12. The method of claim 1, further comprising:
receiving a user profile from an administrator;
identifying an attempt by a profiled user to access session information that the profiled user is not authorized to access; and
sending an alert to the administrator in response to the attempt.

13. A network server comprising:
a processor that, for at least one network resource accessed during a user session, selectively stores session information associated with the network resource, associates the session information with the user session, receives a request from a user to access the session information and, responsive to verifying that the user is authorized to access the session information, provides the session information to the user.

14. The network server of claim 13, wherein the processor establishes the user session with a first communication device and the processor communicates the session information to a second communication device.

15. The network server of claim 13, wherein the user session is established in accordance with a tunneling protocol.

16. The network server of claim 13, further comprising a datastore for storing the session information.

17. The network server of claim 13, wherein the processor communicates the session information to a communication device for storage.

18. An electronic apparatus comprising:
a user interface that presents to a user an option for selectively storing session information associated with a network resource, the user interface comprising at least one indicator that indicates whether the session information is currently being stored for a current user session.

19. The electronic apparatus of claim 18, wherein the indicator further indicates whether session information associated with a previous user session is available to be accessed.

20. The electronic apparatus of claim 19, wherein the indicator is selected to access the stored session information for the current user session or the previous user session.
